(19) United States
(12) Patent Application Publication
(10) Pub. No.: US 2004/0066016 A1
(43) Pub. Date: Apr. 8, 2004

(54) Poles and fastenings for biking upright

(76) Inventor: Pol Raikin, Akko (IL)

Correspondence Address: Pol Raikin, Hotel Argaman 65, P.O. Box 2680, Akko, 24126, IL

(21) Appl. No.: 10/262,961

(22) Filed: Oct. 3, 2002

(51) Int. Cl. B62M 29/00

(52) U.S. Cl. 280/219

(57) ABSTRACT

Poles and fastenings for biking upright allow enabling of the effort of an additional upright cyclist on practically any operator-powered vehicle. Those poles consist of a bar with a handle and a support below. The bar can be resilient and the support may have a pear-shaped form, or it may look as a spike. The support may also contain a roller with an overrunning clutch (or without it). The poles' bars can be interconnected by a crossbar, which can be fixed on the skeleton of the vehicle near the rear wheel with the possibility of sliding in the location clutches. The poles in the cyclist's hands can lean on the road surface or on fasteners provided in a special devices set for biking upright. The fasteners for the legs of upright cyclist contain stationary pedals. The body movements of the upright cyclist are similar to the body movements of a skier. The mutual energies of the cyclists, which can change places during the journey, provide the high efficiency of the operator-powered vehicle, which can become a daily vehicle for many users. Additional two or even three partners will be able to cycle on different tricycle models on which poles and fasteners for biking upright will be used. The operating characteristics of the motor vehicle of “Segway Human Transporter” may be significantly improved by using “poles and fastenings for biking upright”.

### BACKGROUND OF THE INVENTION

1. Field of the Invention

The present invention relates to individual transport means and more particularly to operator powered vehicle such as a bicycle, tricycle, tandem bicycle, scooter and to accompanying sets and devices as well as to sporting devices and trainer-simulators.

2. Description of the Related Art

In all the variety of available operator powered vehicles special attention should be paid to those enabling activation of the greatest number of strong groups of human muscles (for example bicycle disclosed in Russian Pat. No. 1.698.123, 3/1993, Raikin, Int. Cl. B62K 3/00), and also activation of the cyclist weight during riding (refer for example to U.S. Pat. No. 4,349,566, April 1983, Titcomb, U.S. Cl. 280/251 Int. Cl. B62K 21/18 or to the scooter disclosed in U.S. Pat. No. 6,273,439 B1. August 2001 Ray et. al, U.S. Cl. 280/871041 Int., Cl. B62M 1/00). Attention should be also paid to additional possibilities, which are open when riding with a partner, while combing the efforts of both sitting cyclists, for example as in the sectional tandem bicycle disclosed in U.S. Pat. No. 5,836,600, November 1998, Chiu, U.S. Cl. 280/231 Int., Cl. B62K 27/00.

However, the solutions mentioned above did not gain significant prevalence as a day-to-day transport means, first of all because of inadequate level of their operational functionality. The reason was the absent of tandem design or additional sets and devices for the human powered vehicle, which could have allow each cyclist alternate straightening up of his spine during riding upright while using his physical possibilities in the most efficient manner by combing the effort of his numerous strong muscles, his body weight and simultaneously the partner-rider's effort. The lack of mentioned designs or auxiliary devices restrains improvement of operational functionality of the human powered vehicle and to use it as a day-to-day transport means. None of the above inventions and patents, taken either singly or in combination, is seen to describe the instant invention as claimed.

Kamen's motor vehicle “Segway Human Transporter” could have been used as a daily transportation mean. But it is very heavy and expensive, and its operating characteristics are limited in many respects. An acceptable construction with poles might be “Devices Set For Motor-less Vehicle for Biking Upright” (application Ser. No. 10/107,187 for US Patent). Both of the solutions mentioned above do not exclude the possibility of future improvements.

### SUMMARY OF THE INVENTION

The aim of the present invention is to extend the possible use of vehicle as a day-to-day transport means and simultaneously as physical training and fitness tool, significantly improving its functional parameters (power, velocity, distance of riding) without substantial design complications and increase of weight, dimensions and cost. The above aim is attained through more efficient use of the efforts of two or more cyclist-partners, when at least one of them rides upright. Moreover, a possibility is also provided for the riders to exchange seats and poses when stopping in order to change the character of their physical effort and enable the relaxation of certain muscle groups as well as straightening the spine.

Accordingly, it is a principle object of the invention to create a possibility of widespread using of an operator-powered vehicle as a day-to-day transportation mean, thereto “Poles and Fastenings for Biking Upright” contain (and/or):

A pole for biking upright (particularly on a bicycle), which has a long bar with a handle, and a pear shaped support on its lower end.

A pole whose support is a roller.

A pole, the roller of which is equipped with an overrunning clutch.

A pole, the support of which is in the shape of a spike.

A pole, the support of which is in the shape of a hingedly suspended sole.

A pole, which has resilient elements.

A pole, the lower part of which is curved.

A pole, which has a folding construction.

A pole, the bar of which has a stand that uses the skeleton of the vehicle as its support.

A pole extender, which is intended for separate installation on the bar.

A pole, the bar of which is connected to another pole's bar with the help of a crossbar and a bush, which is mounted on the skeleton of the vehicle.

A pole, on the bar of which a limiter is installed.

A pole, on which the ends of the crossbar are hingedly connected to its middle part.

A pole, the crossbar ends of which are curved.

A crossbar with a bush, which is intended for individual installation on the skeleton of the vehicle.

A fastening with a pedal for the leg of an upright cyclist, intended for individual installation on the skeleton of the vehicle.

A crossbar with a bush and/or a fastening with a pedal, all can be realized as an integral part of a specially produced vehicle, used with the above mentioned “Devices Set for Motor-less Vehicle for Biking Upright” or used with the above mentioned “Segway Human Transporter”. The operating characteristics of a vehicle, such as power, speed and trip distance will be significantly increased without rising the dimension, weight and cost. Transportation capacity of the bicycle, as a transportation mean, will be increased in three times. The health and ecological effectiveness will be increased too. Poles and Fastenings are also effective when installed on a tandem bicycle or on a tricycle.

### BRIEF DESCRIPTION OF THE DRAWINGS

The essence of the invention is shown by drawings, which contain the different variants of poles and their fastenings for riding on a bicycle equipped with a devices set, which enables the second cyclist to bike upright.

FIG. 1 shows a pole with a support in the shape of a roller, equipped by an overrunning clutch.

FIG. 2 shows a pole with a spring and supports in the shapes of a roller and a spike.

FIG. 3 shows a removable, pear shaped support with an extender.

FIG. 4 shows poles in the hands of a cyclist standing above the rear wheel of a bicycle, which is equipped by the above mentioned “Devices Set for Motor-less vehicle for Biking Upright”.

FIG. 5 shows using of the poles, which are inserted into special slots.

FIG. 6 shows poles connected by a crossbar.

FIG. 7 shows an installation variant for the crossbar.

FIG. 8 shows a variant of using the poles with the crossbar.

FIG. 9 shows a variant of biking with a fastening and a pedal, both installed on the rear wheel fork.

FIG. 10 shows a variant of biking on the “Segway Human Transporter” with a crossbar and poles.

### DETAILED DESCRIPTION OF THE PREFERRED EMBODIMENT

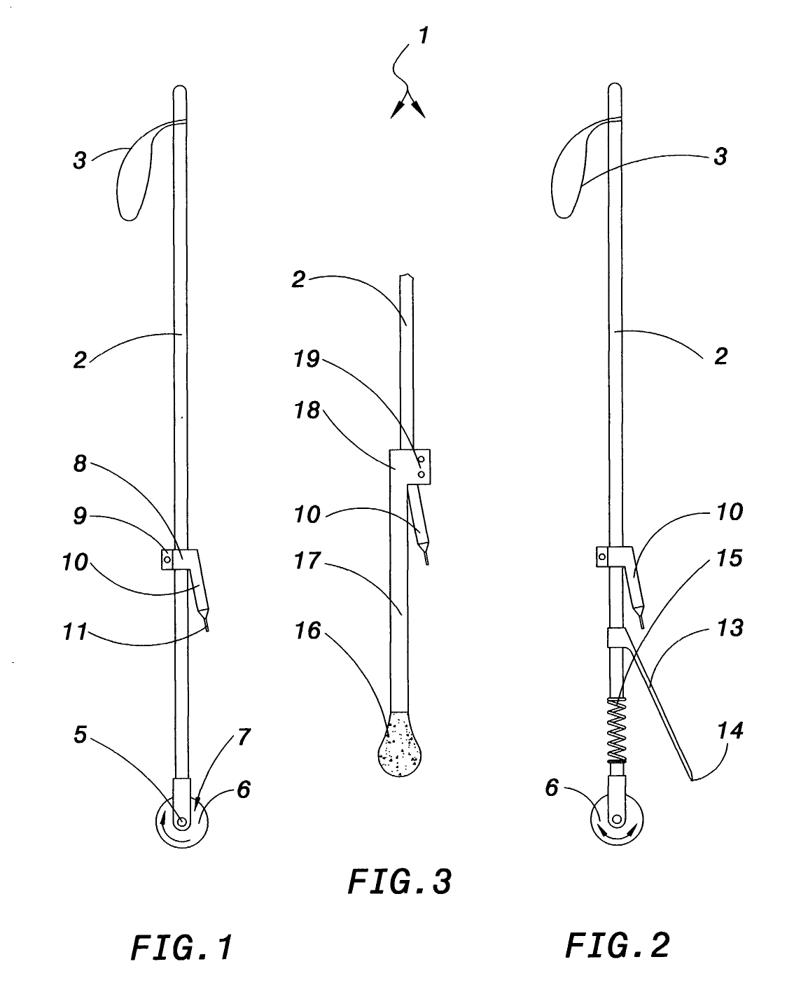

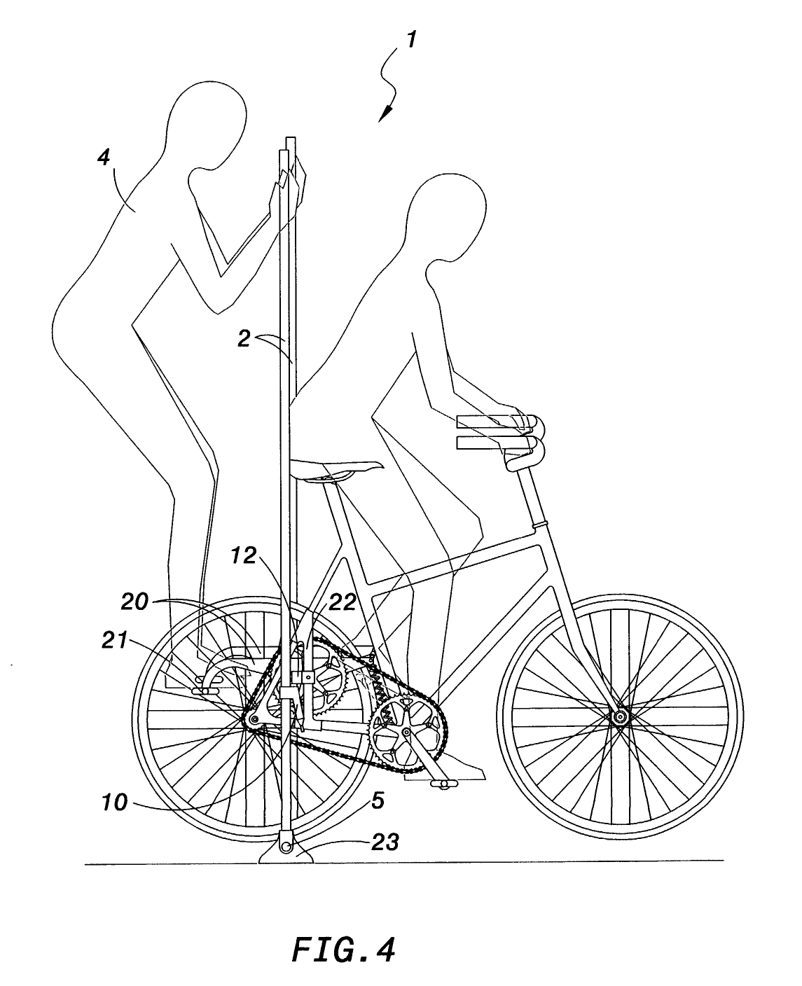

Pole 1 shown in FIG. 1 contains light bar 2 with loop 3 in the upper part of the bar for the hand of the second cyclist 4 (FIG. 4), standing above the rear wheel of the bicycle, which is equipped with a special devices set for biking upright. Pole 1 consists from long bar 2, which is the basis of the pole and is a handle for the biker and from support 6, which is placed on the lower end of this bar and is intended for interaction with the ground surface.

In the lower part of the pole on bar 2 installed a roller shaped support 6 equipped by an overrunning clutch 7, which allows one-sided (clockwise) rotating of roller 6 around axis 5. Stand 10 is fastened on the bar above the support using cramp 8 having two flanges 9 while the cone end of stand 10 together with pin 11 is intended for installation in special slot 12 (FIG. 4) which is installed on bicycle skeleton. The remove ability of stand 10 gives it the ability to be installed separately and the possibility to regulate its position on the pole's bar.

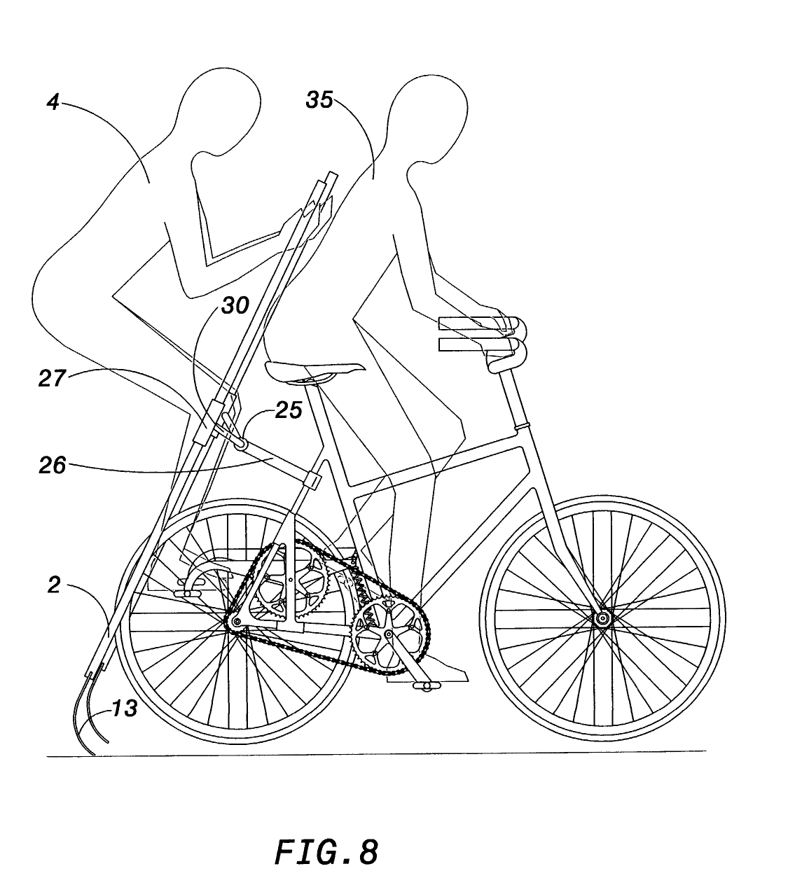

Shown in FIG. 2 the pole has two supports—one of them in the shape of a freely rotating roller 6 and the second is the shape of a spike 13 together with end 14 which provides good cohesion with the ground surface when the pole is pushed, when biker 4 is pushed off by the pole (FIG. 8) and moves ahead the bicycle. The roller shaped support helps in holding the biker's balance. Installed on the bar and operated by pressure direction, spring 15 helps in shock-absorption of the biker's hands and body.

The removable, pear shaped support 16 which has wavy surface is shown in FIG. 3. The wavy surface (this surface may also be ribbed or pinned) enables good cohesion of the support with the ground surface. The support installed on extender 17, on the upper part of which lies cramp 18 together with flanges 19 for fastening on pole's bar 2 which formerly did not have a support.

FIG. 4 shows poles in the hands of biker 4 who is standing above the bicycle's rear wheel when the bicycle is equipped with a special set for biking upright. This set may contain rockers 20 with pedals 21 for the biker's leg and it can also include slots 12 which are installed on stands 22 which are mounted on the bicycle skeleton. FIG. 4 shows that the lower ends of the poles have sole shaped support 23 which are hanged on axis 5 instead of roller 6.

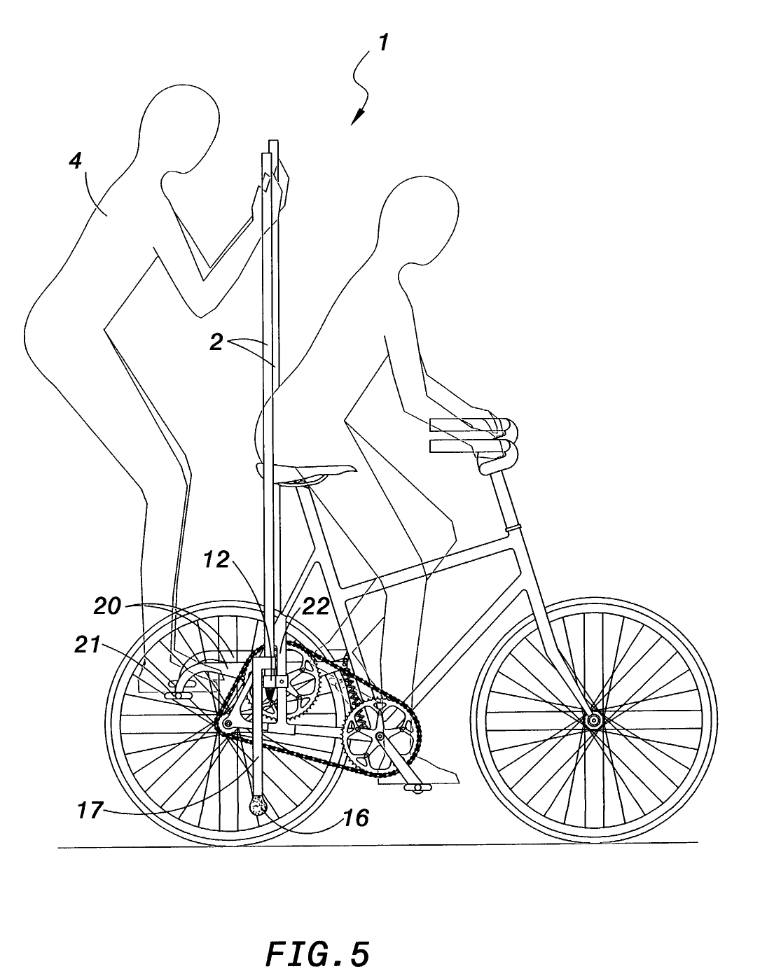

FIG. 5 shows the riding process when the poles installed in slot 12 are used. In this case, the lower pole support is not used and the pole practically leans on the skeleton of the bicycle.

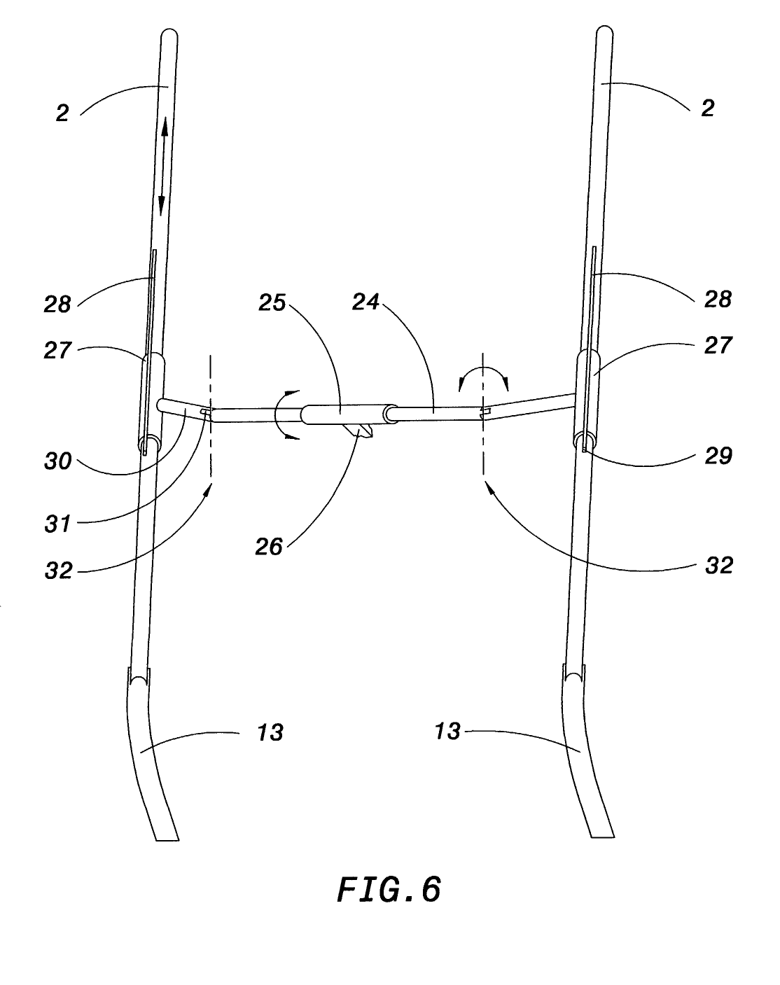

FIG. 6 shows poles, which are interconnected and connected to the bicycle skeleton by special crossbar 24, which passes through common bush 25 installed in shank 26. This shank is fixed on the bicycle skeleton above the rear wheel. The crossbar has, on both of its ends, individual bushes 27 in which bars 2 of poles that have a slipping possibility are inserted. Spikes 13 are used as supports for the poles. Shifting limiters 28, which pass through bushes 27 length cuts, might be installed on shanks 2. The limiter's lower end 29 may be used as a support for the pole when the pole is lifted and the limiter is pulled out from bush 27's length cuts. Then, the small rotation of the pole around its long axis lets end 29 to rest against the upper butt-end pf bush 27. In this case, the support for the pole and the biker's hands will be crossbar 24 for which a split terminal should be used in bush 25.

Crossbar's ends 30 may be connected with their middle part using hinges 31 which allows ends 30 to rotate around axes 32 while deviating from the common straight line. Such a coupling provides the biker with comfort when he is using the poles.

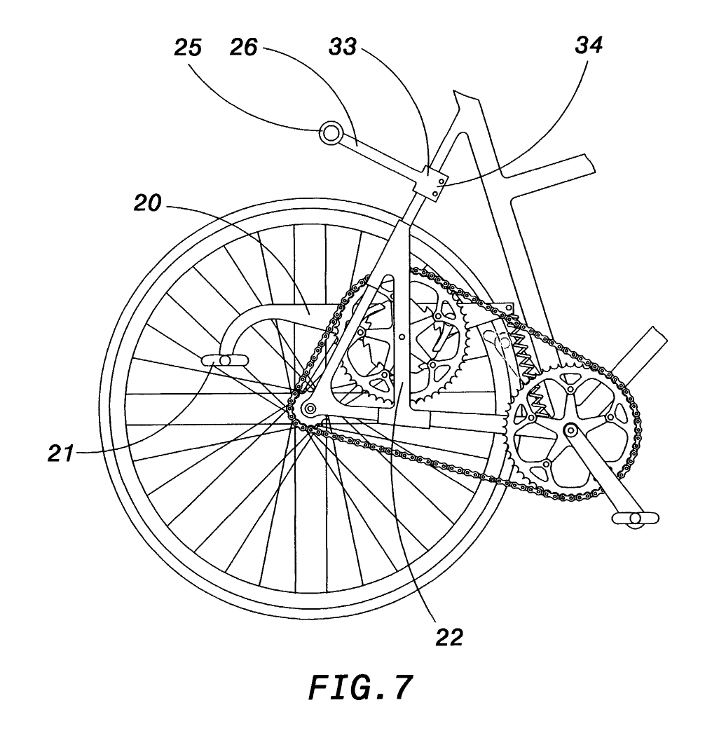

FIG. 7 shows the positional relationship of shank 26 for a crossbar, the rear wheel and the pedal cartridge on the bicycle that is intended specially for biking upright of the second cyclist with poles in his hands. For this purpose, shank 26 with common bush 25 is installed above the rear wheel on the bicycle skeleton using cramp 33 with flanges 34. The bush is intended for the passing of crossbar 24 through it while the poles are positioned on the crossbar ends as shown on FIG. 6.

The using of the crossbar together with the poles in the biking process is shown on FIG. 8, where the pole's supports are paddy spikes 13. The front driver pedals as usual. Such a tandem can be called push-pull.

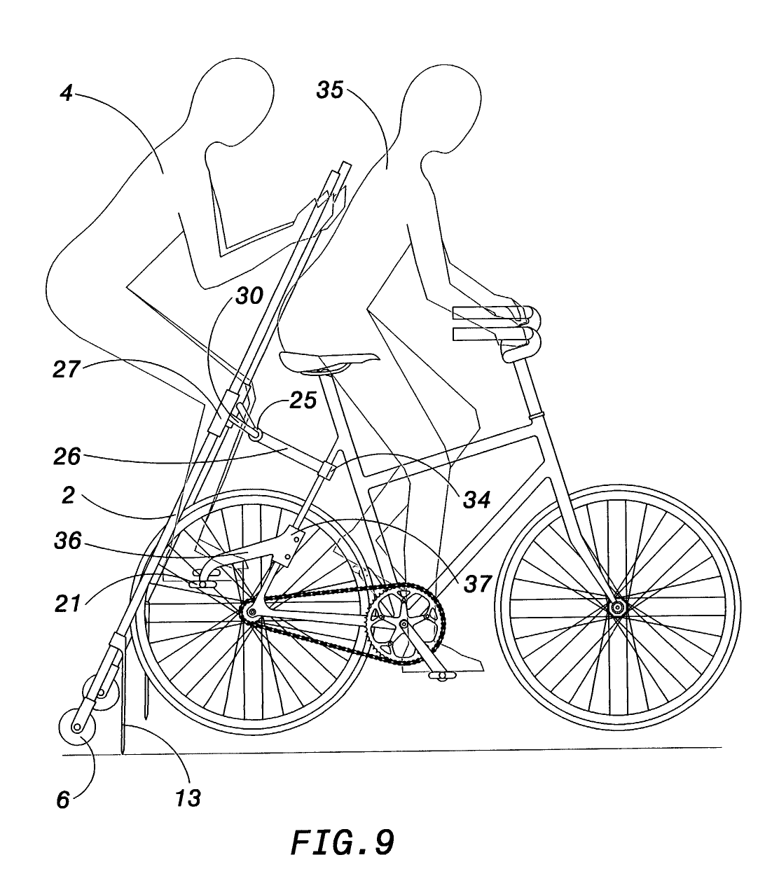

FIG. 9 shows a bicycle driving variant with the using of fastening 36 together with pedals 21 which are mounted on both sides of the rear wheel's fork behind the rear wheel's axis using cramp 37. Using these poles biker 4 pushes the bicycle forward as if he was on skis. Without the poles, the second biker will drive the bicycle while leaning on the shoulders of front cyclist 35 or while holding crossbar 24's ends (FIG. 6).

FIG. 10 shows a variant of using the poles when riding on “Segway Human Transporter” motor device 38. Here, crossbar 24 is used also as a handle bar. Roller 6 is equipped with an overrunning clutch. Bar 2 is made of fibreglass.

While the present invention has been described with what is considered the most practical and preferred embodiment, it is understood that this invention is not limited to the disclosed embodiment but is intended to cover various arrangements included within the spirit and scope of the broadest interpretations and equivalent arrangements.

I claim:

1. A pole for biking upright on an operator powered vehicle, for example a bicycle which contains:
a) A long bar, which is the basis of the pole and is a handle for the operator.
b) A support, placed on the lower end of this bar.

2. A pole, as recited in claim 1, which uses a rotating roller as its support.

3. A pole, as recited in claim 2 wherein the roller is equipped by an overrunning clutch.

4. A pole, as recited in claim 1 wherein its support is spike shaped.

5. A pole, as recited in claim 1 wherein its support is a hingedly hanged sole.

6. A pole, as recited in claim 1 the elements of which are made resilient.

7. A pole, as recited in claim 1 wherein its lower part is curved.

8. A pole, as recited in claim 1 wherein it is made as a folding pole (for example a telescopic pole).

9. A pole, as recited in claim 1, the bar of which has a prop, which is intended for resting on the skeleton of the vehicle.

10. A pole lengthener, which is intended for individual installation on the bar.

11. A pole, as recited in claim 1, the bar of which is connected with the other pole's bar by a crossbar, which passes through a common bush, which is fixed above the vehicle's skeleton in such manner that both of the bars are located on the ends of the crossbar in end bushes with the possibility to slide in them.

12. A pole, as recited in claim 11, on the bar of which a shifting limiter, which limits the movement of the shank in the bush, is placed.

13. A pole, as recited in claim 11 wherein the crossbar ends are hingedly connected with its middle part with the possibility of deviation from the common straight line.

14. A pole, as recited in claim 11 wherein its crossbar has curved ends.

15. The crossbar with the bushes, as recited in claim 11 are intended for individual mounting on the skeleton of the vehicle.

16. A fastening with a pedal for the foot of a standing biker which is intended for individual mounting on the vehicle's skeleton behind the rear wheel's axis.
